(19) United States
(12) Patent Application Publication
(10) Pub. No.: US 2004/0203667 A1
(43) Pub. Date: Oct. 14, 2004

(54) System for locally restricting use of cellphones and other electronic devices

(76) Inventors: Thaddeus Schroeder, Rochester Hills, MI (US); Louis L. Nagy, Warren, MI (US)

Correspondence Address: DELPHI TECHNOLOGIES, INC., M/C 480-410-202, PO BOX 5052, TROY, MI, 48007, US

(21) Appl. No.: 10/388,261

(22) Filed: Mar. 13, 2003

Related U.S. Application Data
(60) Provisional application No. 60/364,224, filed on Mar. 14, 2002.

(51) Int. Cl. H04M 3/42; H04Q 7/20

(52) U.S. Cl. 455/414.1; 455/421

(57) ABSTRACT

The present invention provides systems and methods for locally restricting use of electronic devices in limited areas, and at the same time accommodating emergency situations. The system comprises means for transmitting a signal representing at least one restriction code; means for defining a restricted area operationally coupled with the transmitting means to define the restricted area, and means for restricting operation of electronic devices within the restricted area. The means for defining a restricted area may include an omnidirectional antenna or a directional antenna, or may be operationally coupled with a global positioning system. The transmitting means may be integrated with a cellular phone service system, which communicates on a plurality of control channels and a plurality of voice channels. The methods of the present invention include the steps of receiving a signal capable of representing at least one restriction code; processing the signal to recognize any restriction code; and performing a predetermined action upon recognition of the restriction code. The methods may further include the step of terminating the predetermined action, when the electronic device is removed from the restricted area.

### CROSS REFERENCE TO RELATED APPLICATIONS

This application claims the benefit under Title 35, U.S.C. § 119(e) of U.S. Provisional Patent Application Serial No. 60/364,224, entitled SYSTEM FOR LOCALLY RESTRICTING USE OF CELLPHONES AND OTHER ELECTRONIC DEVICES, filed on Mar. 14,2002.

### BACKGROUND OF THE INVENTION

1. Field of the Invention.

The present invention relates to systems and methods for restricting use of electronic devices within a restricted area.

2. Description of the Related Art.

The use of electronic devices, particularly cellphones, may be totally prohibited in some restricted areas, such as inside airplanes, hospitals, theaters, blasting zones, etc. In addition, laws are being passed to prohibit use of hand held cellphones by operators of moving vehicles. In some other places such as restaurants or theaters, although not prohibited, the use of cellphones is becoming increasingly annoying, to the point that low range (20 to 200 feet) jamming devices that render electronic devices unworkable have been proposed and are currently available and legal in Japan. However, it is doubtful that jamming devices will ever become legal in the United States since both the United States and Britain are firmly against such jamming devices. In general, Europe is also opposed to any unnecessary Radio Frequency (RF) radiated pollution. More importantly, the jamming approach does not accommodate emergency situations, (e.g. an on-the-call physician, parents called by a babysitter, 911 situations, etc). Nevertheless, the desire to have some control over cellphone use is growing.

In general, there are three distinct types of concern about electronic device or cellphone use, namely: auditory noise nuisance (theaters, churches, classrooms) and potential eavesdropping (confidential meetings), RF interference (blasting zones, airplanes), distraction to operators (vehicles, construction equipment). What is needed is a system or method to address these concerns.

### SUMMARY OF THE INVENTION

The present invention provides systems and methods for restricting use of electronic devices within a restricted area, while accommodating emergency communication. The systems of the present invention involve transmitting within a defined restricted area, a signal representing one or more restriction codes for directing electronic devices within the restricted area to perform a predetermined action. The present systems may be set-up as an independent system or an integrated system utilizing a conventional cellular phone service system, or the like to facilitate signal transmission.

In one aspect of the present invention, the system for restricting use of electronic devices includes a device for defining a restricted area operationally coupled with a device for transmitting a signal representing at least one restriction code. The signal prompts the electronic devices to perform a predetermined action, and does not necessarily render the electronic devices unworkable. The system may comprise a transmitter having one or more omnidirectional or directional antennas for defining the restricted area. The restricted area may be operationally defined in reference to a global positioning system.

In another aspect of the invention, the electronic device comprises a receiver adapted to receive a signal representing at least one restriction code, a processor operationally coupled with the receiver to process the signal and recognize the restriction code, and software operationally coupled with the processor to perform a predetermined action upon recognition of the restriction code.

In another aspect, the present invention provides a method for restricting use of electronic devices within a restricted area. The method includes the steps of: transmitting, within a restricted area, a signal representing at least one restriction code, and prompting an electronic device to perform a predetermined action, within the restricted area.

The method of the present invention may further include the steps of receiving the signal, processing the signal and recognizing the restriction code, and performing a predetermined action upon recognition of the restriction codes. The predetermined action may include displaying a warning and identifying a use restriction, identifying the location of a nearest unrestricted area, identifying an alternative electronic device, etc.

The system of the present invention may be independent from or integrated with the cellular telephone service that provides. a plurality of control channels and voice channels, through which the signal representing the restriction code may be transmitted.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a schematic diagram showing steps of a method for restricting use of electronic devices within a restricted area according to one embodiment of the present invention;

FIG. 2 is a schematic diagram showing a basic area geometry for a cellular communication system;

FIG. 3 is a schematic diagram showing a restriction area provided by a single omnidirectional transmission according to one embodiment of the present invention;

FIG. 4 is a schematic diagram showing a restriction area provided by multiple omnidirectional transmitters according to another embodiment of the present invention;

FIG. 5 is a schematic diagram showing a restriction area provided by a single directional transmitter according to another embodiment of the present invention;

FIG. 6 is a schematic diagram showing a restriction area provided by multiple directional transmitters according to another embodiment of the present invention;

FIG. 7 is a schematic diagram showing a restriction area provided by a mix of the transmitters according to another embodiment of the present invention; and

FIG. 8 is a map diagram showing a GPS area restriction geometry.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The embodiments disclosed below are not intended to be exhaustive or limit the invention to the precise form disclosed in the following detailed description. Rather, the embodiments are chosen and described so that others skilled in the art may utilize their teachings.

This invention relates to a new RF/electronic system that permits the desired control of electronic devices use in limited areas without resorting to jamming, and at the same time accommodating emergency situations. The present invention permits control of electronic devices including cellphone use over identified service areas (e.g., dynamite blasting areas), buildings (e.g., hospitals and theaters) and other facilities (e.g., airplanes and automobiles).

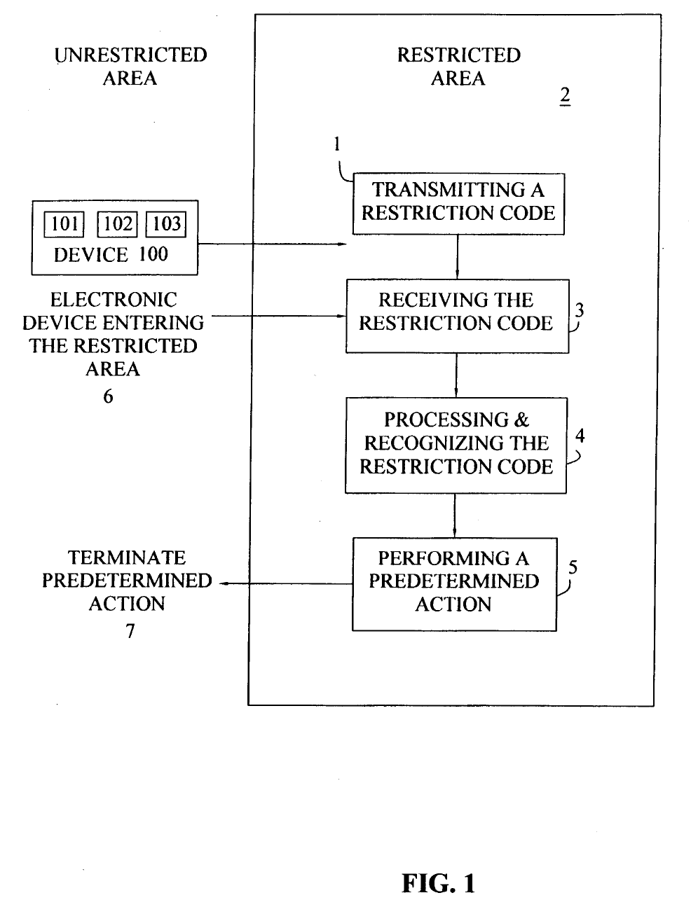

As shown in FIG. 1, the method of the present invention generally involves a series of steps, which starts with step 1 of transmitting a signal representing a restriction code. The restriction code is capable of compelling an electronic device entering designated restricted area 2 to receive 3 and recognize 4 the code and perform 5 a predetermined action corresponding to the restriction. The electronic device 100 may have a receiver 101 for receiving the signal, and processor 102 for processing and recognizing the restriction code, and software 103 for enabling the electronic device to perform the predetermined action. The use restriction of the electronic device may start upon entering 6 and generally remain as long as electronic device 100 stays in the restricted area or for the duration of the restriction. Once the electronic device leaves restricted area, the use restriction may be terminated in step 7.

While some restrictions need to address auditory noise and potential eavesdropping in designated areas, it is the power level of radiated RF energy that needs to be limited when RF interference is of concern in a particular area (e.g. blasting zone). A still different criterion may be used for cellphone restrictions if the user operates a vehicle. In this case, it might be required to impose certain restrictions on the cellphone use to minimize distraction to the operator. These restrictions may be imposed in response to one or more parameters identifying the current state of the operator and/or the vehicle, such as vehicle speed, steering and braking actions, and possibly some other operator and vehicle related information.

Although this invention is described primarily with the exemplary use of cellphones, there are also situations (e.g. on airplanes) where the use of other electronic devices (computers, electronic games, etc.) is prohibited, or undesired and cannot be controlled by jamming or other intrusive procedures. The exemplary cellphone restriction approach can also be extended to include these other electronic devices.

Two general approaches may be taken. In the first approach, the restriction system is independent of the cellular service provider. In this way, the RF transmission and reception of the signal from the service provider remain unchanged. The restriction system uses a separate short range RF communication link to impose restrictions (e.g. a “Blue Tooth” system). In the second approach, the restriction system is integrated into the communication system 10 of the cellular service provider, which detects a restriction request and imposes the restriction through its own communication network.

The independent restriction system requires cellphones to be equipped with an additional standardized receiver/decoder device. This device may be in the form of a small and inexpensive Wireless-Integrated Micro-System (WIMS). Correspondingly, the restricted area may contain one or more standardized transmitters transmitting a desired restriction code on some standardized frequency. This transmitter, or transmitters may be placed on the premises by their owner or administrator and remain under his/her control.

Whenever a cellphone or other electronic device is operational in restricted area, the receiver/decoder device in the cellphone will detect the transmitted “inhibiting” code (which could be just a single number identifying the particular restriction) and the appropriate information will be processed by the phone's internal microprocessor. This applies to both an operating cellphone that is carried into restricted area and one that is turned-on in restricted area. Depending on the code (i.e., there may be several codes corresponding to different degrees of restriction), the microprocessor will then direct the cellphone to initiate one or more of the following actions: (1) display a warning and identify the existing restriction, (2) identify the location of a nearest unrestricted area or a land line phone, (3) block any dialing out except for specific emergency numbers, such as 911 (at a normal or reduced power level), (4) switch from sound ringer to a silent one (e.g. vibration) (5) modify the reception, (6) modify the reply, and (7) accommodate emergency communications by switching the cellphone operation to a lower, acceptable power level.

One way to modify the reception is to switch the cellphone to a “virtual turn-off” mode, in which there is no reception. Another way is to silent ring alerts to a message being left in the voicemail box, or to display only the text including the caller's name. In addition, the voice message may have a reduced volume or a limited duration.

The reply may be modified by not permitting transmission of the reply, or allowing only text reply, but not voice reply. The text reply may be entered manually, or selected from a list of stored text messages, and the text message may be delivered as text or as prerecorded or synthesized voice message.

If the concern is not auditory disturbance, but RF interference is caused by the cellphone, then to accommodate emergency situations, the restriction code may switch the cellphone operation to a lower, acceptable power level, which may or may not be sufficient to establish a cellphone connection with the nearest transmitter tower. Hence, under some circumstances, it might be required for the restriction code transmitter to have the additional capability to relay such low power level emergency calls to a land phone line or the nearest cellphone tower, thus creating in restricted area, a local mini-cell for emergency calls.

The restrictions listed above are only some examples of possible restrictions. Depending on particular circumstances other case-specific restrictions may be created. Additionally, once the cellphone leaves restricted area, all prior settings may be restored.

As in the above described independent cellphone restriction system, the owner or administrator of the premises places their one or more transmitters which broadcast a restriction code over the desired area. In the integrated cellphone restriction system, the restriction code, is transmitted over one or more of the control channels. In this case, the cellphones do not require a separate receiver, just a software modification in their microprocessors.

At present, the current conventional North American mobile telephone system includes the North American Advanced Mobile Phones Service (AMPS; 824-849 & 869-894 MHz) and the North American Personal Communication Service (PCS: 1.85 to 1.99 GHz). The two services differ as follows:

AMPS has a total bandwidth of 50 MHz that is separates into two frequency bands for “wired” (i.e., land-based wireline telephone networks) and “wireless” (composite wireline/wireless telephone networks) service providers. Full-duplex communication is achieved by dividing each of these into two 12.5 MHz sub-bands (A and B) for forward (downlink) and reverse (uplink) communication while maintaining a 45 MHz separation for forward and reverse communication with a 20 MHz guardband. Each of these sub-bands was divided into 416 channels (i.e., frequency-division multiple access, FDMA) each having a bandwidth of 30 kHz. This division creates 416 full-duplex communication channels with 21 of these being used as control channels and 395 as voice channels. Control channels are required for channel assignment, paging, sync, messaging, etc. Voice channels are for use for supporting voice (conversation) communication. In addition, the application of time-division multiple access (TDMA) techniques provide time sharing between mobile units that effectively increases the capability of each channel from a single user to three to six users. Code-division multiple access (CDMA) can also be used to further increase channel capacity.

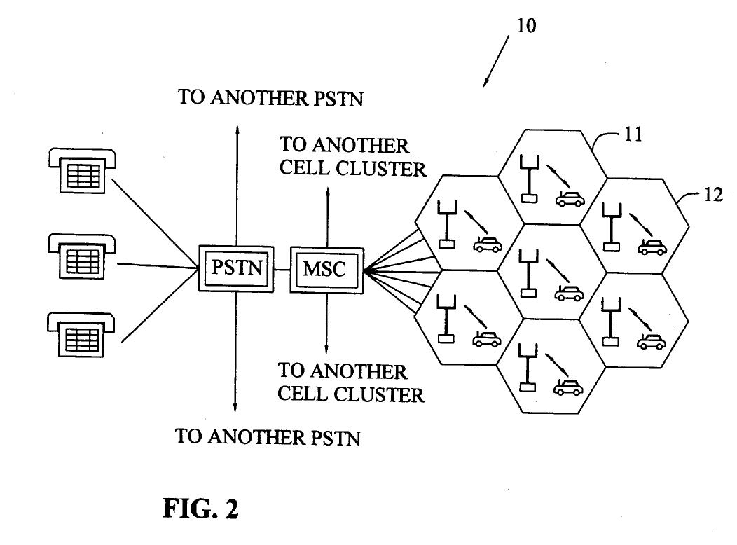

As shown in FIG. 2, the basic area coverage of the cellular communication system 10 consist of a widely use seven cell plan 11 into which all available channels are evenly distributed. Each one of these seven cells 12 is then assigned a unique set of RF operating frequencies. The basic cell plan 11 is then repeated as needed to cover the desired service area with the various cell arranged in such a fashion as to minimize frequency interference between the cells.

PCS has a total bandwidth of 120 MHz that is separates into two frequency bands: major trading areas (MTAs) and basic trading areas (BTAs). MTAs are allocated a 45 MHz band and the BTAs a 15 MHz band. Full-duplex communication is achieved by dividing each of these into two 60 MHz sub-bands for forward and reverse communication with a 20 MHz guardband. These sub-bands are then divided into channels that support voice communication.

When the cellphone power is operational and the cellphone is neither placing nor receiving calls, the cellphone will default to idle mode. In this mode, the cellphone will initially scan the 21 control channels, select the strongest (which is usually the nearest), and monitor this control channel until the call status is change. If the control channel falls below a reference, the cellphone will again scan the 21 channels to determine the new strongest channel and select it for the call monitoring function.

The actual communication protocol within a cellphone cell is dependent on the party that who generates and the one that receives the call: 1) initiated non-cellphone call to a cellphone, 2) initiated cellphone call to a non-cellphone, and 3) cellphone call to another cellphone. The following table shows a brief description of the various protocols assuming that the cellphone is operational and in its idle mode:

| | | Initiated cellphone call |
|---|---|---|
| | | to another cellphone |
| | | (i.e., within the mobile |
| Initiated non-cellphone | Initiated cellphone call | switching center |
| call to a cellphone; | to a non-cellphone: | (MSC) network): |
| Non-cellphone initiates | Cellphone user enters | Cellphone user enters |
| a call | desired phone number and | desired phone number |
| | presses the “SEND” key | and presses the “SEND” |
| | | key |
| Public switching | The cellphone waits for | The cellphone waits for |
| telephone network | the busy/idle signal of the | the busy/idle signal of |
| (PSTN) forwards the | control channel to turn to | the control channel to |
| call and cellphone | the idle state, and then | turn to the idle state, and |
| number to a mobile | sends this information and | then sends this |
| switching center (MSC) | other necessary data to the | information and other |
| | appropriate base station | necessary data to the |
| | via the control channel | appropriate base station |
| | | via the control channel |
| The MSC then forwards | The base station informs | The base station informs |
| the call and number to | the MSC | the MSC |
| all cell base stations | | |
| Cell base stations | The MSC assigns a free | The MSC assigns two |
| transmit a paging signal | voice channel with a SAT | free voice channels with |
| with the desired | signal and transmits this | SAT signals and transits |
| cellphone number over | information to the | this information to the |
| their control channels | cellphone via the control | cellphones via the |
| | channel | appropriate base stations |
| | | and control channels |
| The desired cellphone | The MSC sends the | The cellphones tune to |
| will recognize its | desired phone number to | the assigned |
| number in the paging | the PSTN | frequencies, and send |
| message, switch from | | back their SAT signal |
| the idle monitoring | | over their assigned voice |
| mode to an active mode, | | channel to confirm |
| wait for the busy/idle | | connection |
| signal to turn to the idle | | |
| state, and respond to this | | |
| page by transmitting its | | |
| identification number | | |
| over the same control | | |
| channel | | |
| The base station will | The PSTN then provides | |
| monitor its control | connectivity to the non- | |
| channel for this response | cellphone | |
| and inform the MSC | | |
| that the cellphone is | | |
| available | | |
| The MSC then assigns a | The cellphone tunes to the | |
| free voice channel and | appropriate frequency, | |
| informs the base station | and send back the SAT | |
| | signal over this voice | |
| | channel to confirm connection | |
| The base station then | | |
| transmits this channel | | |
| number to the cellphone | | |
| and turns on the | | |
| assigned voice number | | |
| with a supervisory audio | | |
| tone (SAT) | | |
| The purpose of the SAT | | |
| is to indicate continuity | | |
| of the cellphone | | |
| conversation | | |
| The cellphone receives | | |
| the channel number, | | |
| computes its frequency, | | |
| tunes to that frequency, | | |
| and transmits back the | | |
| SAT signal to confirm connection | | |

Based on the above description, a cellphone can neither receive nor initiate a call if the control channel it is monitoring is always signaling it is in a busy state.

Accordingly, several possible approaches to implement the integrated cellphone system may be taken. In the first approach, one may select the strongest control channel in each sub-band A and B, at the particular location, for the transmission of the restriction code in the form of a very short duration signal with a repetition rate of e.g. 1.0 second. Alternatively, the restriction code could be broadcast, in a similar fashion, over all control channels in both sub-bands A and B, e.g. sweeping through all channels sequentially. Sending the restriction code over the control channel or channels would only prevent activating the cellphone in restricted area, but not necessarily when the cellphone enters restricted area already operational.

In the second approach, cellphone operation in all cases, whether operational or not when entering restriction area, may be restricted. The restriction code could be broadcast, in a similar fashion as described above, but over all voice channels.

In the third approach, the methods described in the first and the second approaches may be combined together, and could be used in situations where power level limitation was the required restriction mode.

In another aspect of the invention, both the independent and the integrated restriction systems define the perimeter of restricted area. The perimeter may be defined by the RF power level of the restriction code transmitter or transmitters in conjunction with the directionality of their antennas. The emerging trend to include Global Positioning System (GPS) receivers in cellphones provides another way for defining the perimeter of restriction areas.

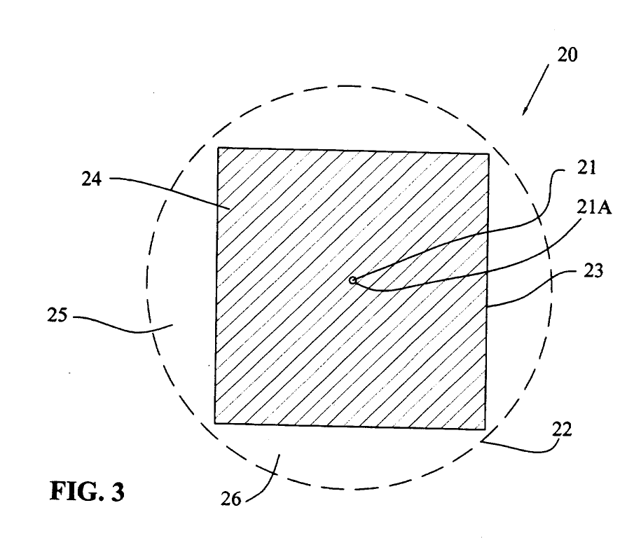

FIGS. 3 through 7 show various examples of defining the perimeter of restriction areas through the use of single and multiple transmitters with directional and omnidirectional antennas. Depending on the priorities, one can choose either to cover all the desired area and tolerate the presence of restriction beyond the desired perimeter, or accept unrestricted areas within the perimeter of the desired restriction area. However, it might be difficult to obtain an exact match between the desired and the actual perimeters of the restriction areas.

For example, according to FIG. 3, system 20 of the present invention includes transmitter 21 having an omnidirectional antenna 21A sending signal representing the restriction code in a circular pattern within actual perimeter 22. The desired restricted area 24 (shaded) defined by desired perimeter 23 is smaller than and has a different shape from actual restricted area 25. The differential shape and size creates non-overlapping area 26, which situates within actual restricted area 25, but outside desired restricted area 24 . The use of the electronic devices within actual restricted area 25 including non-overlapping area 26 may be restricted.

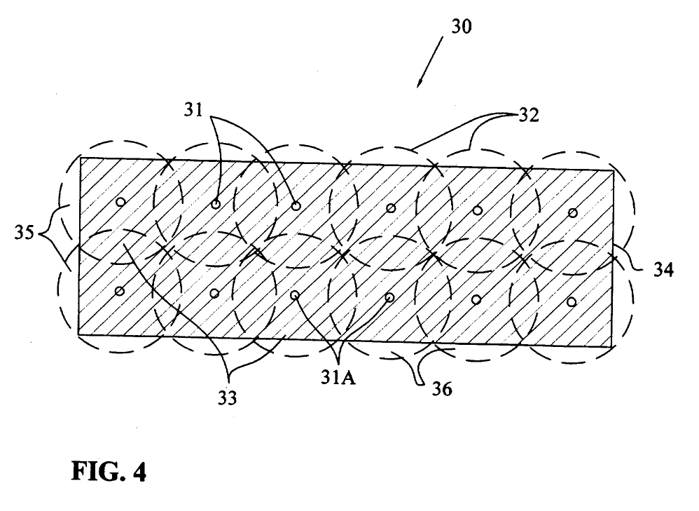

In another example, shown in FIG. 4, system 30 includes a plurality of transmitters 31, each having an omnidirectional antenna 31A. Plurality of transmitters 31 send the signal representing the restriction code within actual restricted area 35, as defined by actual perimeter 32. However, desired restricted area 33 (shaded) defined by desired perimeter 34 is relatively smaller than and different in shape from the actual restricted area 35. As a result, non-overlapping areas 36, which situate outside desired restricted area 33, but inside actual restricted area 35 are created. The use of the electronic devices within actual restricted area 35 including non-overlapping area 36 may be restricted.

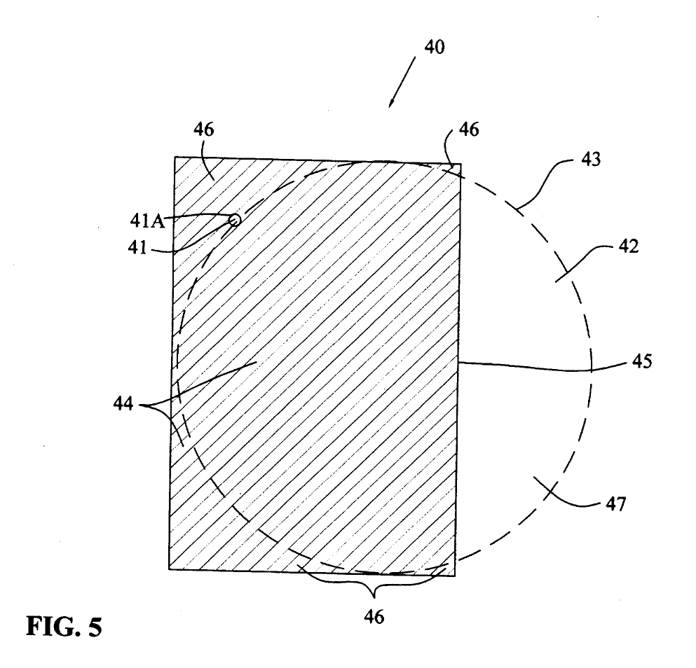

In FIG. 5, system 40 includes transmitter 41 having a directional antenna 41 A. Transmitter 41 sends a signal representing a restriction code within actual restricted area 42, which is defined by actual perimeter 43. Desired restricted area 44 (shaded) defined by desired perimeter 45, forming non-overlapping areas 46 and non overlapping area 47 with actual restricted area 42. Non-overlapping areas 46 situate inside desired restricted area 44, but outside actual restricted area 42, thus the electronic devices within non-overlapping areas 46 may not be restricted. In contrast, the electronic devices within non-overlapping area 47, which situates inside the actual restricted area 42, but outside desired restricted area 44, may be restricted.

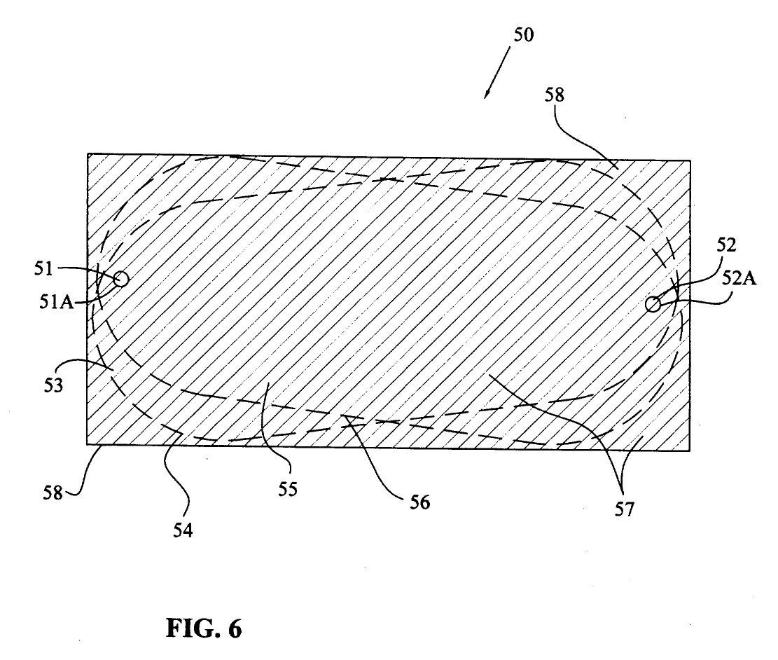

In FIG. 6, system 50 includes transmitters 51 and 52, each having a directional antenna 51A, 52A. Transmitter 51 sends a signal representing a restriction code within first actual restricted area 53, which is defined by first actual perimeter 54. Similarly, transmitter 52 sends the signal within second actual restricted area 55, which is defined by second actual perimeter 56. First actual restricted area 53 and second actual restricted area 55 overlap. Desired restricted area 57 (shaded) is defined by desired perimeter 58. In this specific example, desired restricted area 57 is slightly larger than the combined actual restricted areas 53 and 55. The electronic devices within non overlapping area 58, which is inside desired restricted area 57, but outside the actual restricted areas 53 and 55, may not be restricted.

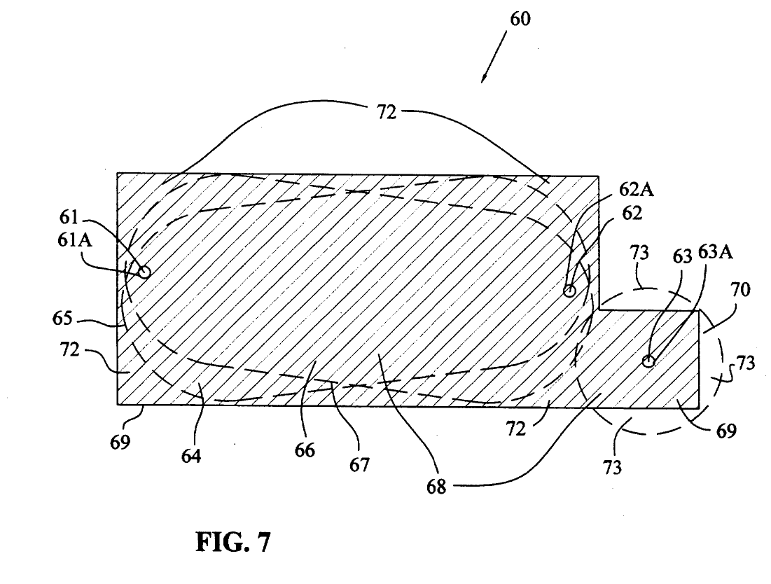

In FIG. 7, system 60 includes transmitters 61-63. Each of transmitters 61 and 62 has a directional antenna 61A and 62A. The signals sent by transmitters 61 and 62 cover the actual restricted areas 64 and 66, which are defined by actual perimeters 65 and 67, respectively. In contrast, transmitter 63 has an omnidirectional antenna 63A. The signal sent by transmitter 63 covers actual restricted area 70. Desired restricted area 68 is defined by desired perimeter 69. As depicted, the electronic devices within non-overlapping areas 72, which situate inside desired restricted area 68, but outside actual restricted areas 64 and 66, may not be restricted. In contrast devices within non-overlapping areas 73, which are inside actual restricted area 70, but outside desired restricted area 68 may be restricted.

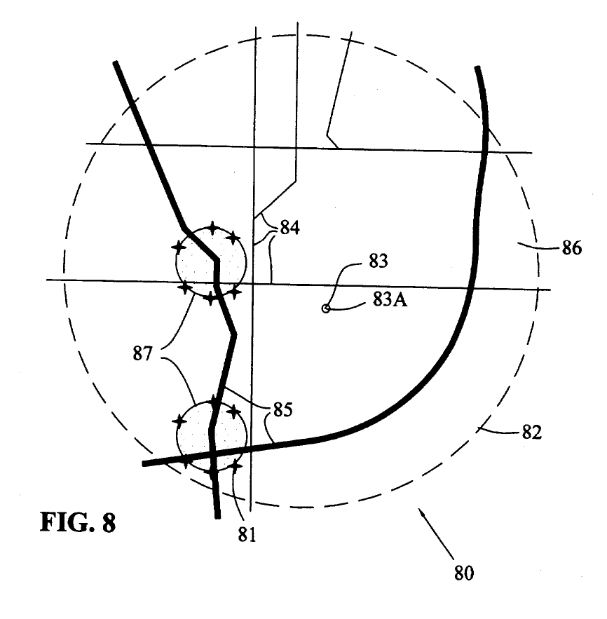

As depicted in FIG. 8, system 80 has transmitter 83 having an omnidirectional antenna 83A sending a signal representing a restriction code within a transmission area 86 defined by perimeter 82. The transmission area 86 covers desired restricted areas 87 which can be identified by GPS coordinates 81, which determine the distances from surface roads 84 and highways 85. System 80 provides electronic devices or cellphones equipped with a GPS receiver which receive and recognize the GPS coordinates. The restriction code is received by the cellphones, either when operating cellphones enter the desired restricted areas 87, or when the cellphones are first turned on in the desired restricted areas 87. The microprocessor of the cellphone will then determine if the cellphone GPS coordinates are within the restricted area GPS coordinates 81. If the cellphones are within the restricted area 87, the restriction code will be imposed. Transmitter 83 shown in FIG. 8 may be a portable dedicated restriction code transmitter operated by the authority conducting the particular activity (e.g. blasting) in that area. Alternatively, transmitter 83 may be a commercial cellphone transmitter tower in the vicinity of such an operation that has been requested by the proper authority to transmit the restriction code and GPS restriction area coordinates on its control and voice channels during a specified time period.

Although the exemplary embodiment of the present invention applies to the restricted use of cellphones and other electronic devices in designated areas, it may extend to other applications having similar system configurations.

One possible extension of this invention is its use for regional emergency alerts. A designated code sent by a cellular service provider or by some kind of a dedicated regional emergency transmitter may interrupt all operational cellphones in its range with an appropriate emergency message. This message may be sent together with the code, or retrieved from canned messages stored in the cellphone memory. This message may have the form of a text, synthesized or prerecorded speech, or direct the cellphone user to dial a specific emergency information number. The code could even, if the user chooses, automatically dial this number, or switch to a cellular voice channel that might be designated to transmit emergency information.

While the present invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A system for restricting use of electronic devices within a restricted area comprising:
means for transmitting a signal representing at least one restriction code; said restriction code is adapted to direct an electronic device to perform a predetermined action;
means for defining a restricted area operationally coupled with said transmitting means to define the restricted area, and
means for restricting operation of electronic devices within the restricted area, said restricting means coupled to said transmitting means to enable transmitting of the signal within the restricted area.

2. The system of claim 1, wherein said transmitting means comprises at least one transmitter.

3. The system of claim 2, wherein said means for defining a restricted area comprises at least one omnidirectional antenna.

4. The system of claim 2, wherein said means for defining a restricted area comprises at least one directional antenna.

5. The system of claim 2, wherein said means for defining a restricted area comprises at least one omnidirectional antenna and at least one directional antenna.

6. The system of claim 1, wherein said means for defining a restricted area operationally coupled with a global positioning system (GPS) to define the restricted area.

7. The system of claim 1 further comprising an electronic device having:
a receiver for receiving said signal,
a processor operationally coupled with said receiver to process the received signal and recognize the restriction code; and
software operationally coupled with said processor to perform the predetermined action upon recognition of the restriction code.

8. The system of claim 2 further comprising a cellular phone service system, said cellular phone service system communicating on a plurality of control channels and a plurality of voice channels for transmitting the signal.

9. The system of claim 8, wherein said transmitting means is adapted to transmit the signal through at least one of said control channels.

10. The system of claim 8, wherein said transmitting means is adapted to transmit the signal through at least one of said voice channels.

11. The system of claim 8, wherein said transmitting means is adapted to transmit the signal through at least one of said control channels and at least one of said voice channels.

12. The system of claim 8, wherein said means for defining a restricted area is further operationally coupled with a global positioning system (GPS) to define the restricted area.

13. The system of claim 8 further comprising an electronic device having:
a receiver adapted to receive a signal representing a restriction code;
a processor operationally coupled with said receiver to process the received signal and recognize the restriction code; and
software operationally coupled with said processor to perform a predetermined action upon recognition of the restriction code.

14. An electronic device comprising:
a receiver adapted to receive a signal representing at least one restriction code;
a processor operationally coupled with said receiver to process the received signal and recognize the restriction code; and
software operationally coupled with said processor to perform a predetermined action upon recognition of the restriction code.

15. The electronic device of claim 14 further comprising a global positioning system (GPS) receiver for receiving a signal representing a GPS location; said processor operationally coupled with said GPS receiver to recognize the GPS location.

16. The electronic device of claim 14 further comprising a mobile telephone.

17. A method for restricting use of electronic devices within a restricted area comprising the steps of:
(a) transmitting a signal representing at least one restriction code within a restricted area; and
(b) prompting an electronic device to perform a predetermined action when the device is within the restricted area.

18. The method of claim 18 further comprising the step of:
(c) defining the restricted area coupled with said transmitting step.

19. The method of claim 18 wherein said (a) transmitting step utilizes a cellular phone service system, wherein said cellular phone service system communicates on a plurality of control channels and a plurality of voice channels for transmitting the signal.

20. The method of claim 19, wherein said transmitting step is carried out through at least one of the control channels.

21. The method of claim 19, wherein said transmitting step is carried out through at least one of the voice channels.

22. The method of claim 19, wherein said transmitting step is carried out through at least one of the control channels and at least one of the voice channels.

23. The method of claim 17, wherein said performing a predetermined action includes at least one of:
i. displaying a warning and identifying a use restriction;
ii. identifying the location of a nearest unrestricted area;
iii. identifying an alternative electronic device; and
iv. switching to a virtual turn-off mode, wherein only an emergency use is permitted.

24. The method of claim 17, wherein said performing a predetermined action includes at least one of:
i. displaying a warning and identifying a use restriction;
ii. identifying the location of a nearest unrestricted area;
iii. identifying an alternative land line device;
iv. blocking any dialing out except for specific emergency numbers;
v. switching from sound ringer to a silent ringer;
vi. switching to a virtual turn-off mode, wherein only emergency use is permitted;
vii. silent alerting to a message being left in a voicemail box;
viii. reducing a voice message volume;
ix. limiting a voice message duration;
x. disabling transmission of a voice reply; and
xi. allowing transmission of only a text message.

25. The method of claim 17 further comprising the step of:
(e) terminating the predetermined action.

26. A method for restricting use of electronic devices comprising the steps of:
(a) receiving a signal capable of representing at least one restriction code;
(b) processing the signal to recognize any restriction code; and
(c) performing a predetermined action upon recognition of the restriction code.

27. The method of claim 26, wherein said performing a predetermined action includes at least one of:
i. displaying a warning and identifying a use restriction;
ii. identifying the location of a nearest unrestricted area;
iii. identifying an alternative electronic device; and
iv. switching to a virtual turn-off mode, wherein only an emergency use is permitted.

28. The method of claim 26, wherein said steps (a)-(c) are performed within a mobile phone.

29. The method of claim 28, wherein said performing a predetermined action includes at least one of:
i. displaying a warning and identifying a use restriction;
ii. identifying the location of a nearest unrestricted area;
iii. identifying an alternative land line device;
iv. blocking any dialing out except for: specific emergency numbers;
v. switching from sound ringer to a silent ringer;
vi. switching to a virtual turn-off mode, wherein only emergency use is permitted;
vii. silent alerting to a message being left in a voicemail box;
viii. reducing a voice message volume;
ix. limiting a voice message duration;
x. disabling transmission of a voice reply; and
xi. allowing transmission of only a text message.

30. The method of claim 26 further comprising prior to the step of (c) the step of (d) receiving and recognizing a signal representing a GPS location.

31. The method of claim 26 , wherein said performing a predetermined action includes disabling the electronic devices to allow only emergency communication.

32. The method of claim 26 further comprising the step of:
(e) terminating the predetermined action.
